(19) United States
(12) Patent Application Publication
(10) Pub. No.: US 2010/0082725 A1
(43) Pub. Date: Apr. 1, 2010

(54) CONTROL TERMINAL FOR GIVING CONTENT REPRODUCTION COMMAND, CONTENT RELAY DEVICE AND REMOTE CONTENT REPRODUCTION SYSTEM

(75) Inventor: Teruhiko Onishi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/566,102

(22) Filed: Sep. 24, 2009

(30) Foreign Application Priority Data
Sep. 26, 2008 (JP) 2008-247719

(51) Int. Cl. G06F 15/16; H04N 7/26

(52) U.S. Cl. 709/201; 386/E05.001; 386/124

(57) ABSTRACT

A portable terminal includes: a unit for connecting to a first local area network connected with the reproduction unit; a unit for connecting to a second connection unit of the second local area network through a first connection unit; a unit for accepting a command to display a list of remote contents and outputting a remote content list acquisition request to the second connection unit; a unit for receiving a remote content list data, from the second connection unit, and storing the remote content list data in a content information storage unit; a unit for displaying a list of the content names included in the remote content list data; and a unit for accepting, a reproduction command to the reproduction unit, a reproduction request containing the address of the second connection unit stored in the address storage unit and the location information, stored in the content information.

### CROSS-REFERENCE TO RELATED APPLICATIONS

This application is based upon and claims the benefit of priority of the prior Japanese Patent Application No. 2008-247719, filed on Sep. 26, 2008, the entire contents of which are incorporated herein by reference.

### FIELD

The embodiments discussed herein are related to a technique in which the content held by a device connected to one local area network is reproduced by a reproduction device connected to another local area network.

### BACKGROUND

In recent years, an agreement has been reached to make an arrangement under DLNA (Digital Living Network Alliance) in which the PC and the HDD (hard disk drive) recorder, TV and the like devices for home use are connected to a network to share the contents such as music, photos and dynamic images seamlessly. The very agreement is sometimes referred to as DLNA. The devices adapted for DLNA (hereinafter referred to as the DLNA devices) have recently begun to be placed on the market. By connecting a DLNA device to the network in a home, the content (a photo, for example) stored in a PC in one room can be viewed on a TV in another room, for example, the living room. For more details of the DLNA, refer to the website <URL:http://www.dlna.org/home>, etc.

The DLNA devices include a DMS (digital media server) for holding and providing the contents to other DLNA devices, a DMP (digital media player) adapted to retrieve and reproduce the contents, a DMC (digital media controller) capable of retrieving the contents and giving a reproduction command to other devices, and a DMR (digital media renderer) for reproducing the contents on the DMS in response to a command from the DMC. These DLNA devices include the UPnPDA (universal plug and play device architecture) function to detect other DLNA devices or retrieve the contents thereof. For example, a DLNA device transmits a predetermined packet based on UPnPDA to the local area network, and detects another DLNA device from the response to the packet. For this reason, the DLNA device, though capable of detecting other DLNA devices connected to the same local area network, cannot detect the DLNA devices connected to other local area networks. Incidentally, a configuration in which the DLNA devices connected to other local area networks can be detected would make it possible for the DLNA devices to be accessed by a multiplicity of unspecified devices through external networks and thus pose a security problem.

### BRIEF DESCRIPTION OF DRAWINGS

FIG. 1 is a diagram depicting a system configuration according to an embodiment;

FIG. 2 is a block diagram depicting the DLNA-GW function;

FIG. 3 depicts an example of the data stored in an authentication information storage unit;

FIG. 4 depicts an example of a terminal management table stored in a terminal management table storage unit;

FIG. 5 depicts an example of a content table stored in a content table storage unit;

FIG. 6 is a diagram depicting the function blocks of a control terminal;

FIG. 7 is a diagram for explaining the data stored in a content information storage unit;

FIG. 8 depicts the flow of the authentication information registration process;

FIG. 9 depicts a flow of the authentication process (first part);

FIG. 10 depicts a flow of the authentication process (second part);

FIG. 11 depicts the processing flow (first part) for acquiring the content list data;

FIG. 12 is a diagram for explaining the process of generating the content table;

FIGS. 13A to 13C depict examples of the directory list screen;

FIG. 14 depicts the processing flow (second part) for acquiring the content list data;

FIGS. 15A to 15D depict an example of the content list data;

FIG. 16 is a diagram for explaining the content list data;

FIG. 17 depicts an example of the content list screen;

FIG. 18 depicts the processing flow (first part) for reproducing the content;

FIG. 19 depicts an example of a player list screen;

FIG. 20 depicts the processing flow (second part) for reproducing the content;

FIG. 21 depicts the processing flow (third part) for reproducing the content;

FIG. 22 depicts the processing flow for searching the content;

FIG. 23 depicts an example of a search condition input screen;

FIG. 24 depicts an example of the content list screen;

FIG. 25 depicts another example of the configuration of the system according to an embodiment;

FIG. 26 depicts the processing flow for transferring the content data; and

FIG. 27 is a function block diagram of a computer.

### SUMMARY

According to an aspect of the embodiment, a portable terminal includes:

a unit for connecting to a first local area network connected with a reproduction unit;

a unit for accepting a command from a user to connect to a second local area network and connecting to a second connection unit of the second local area network through a first connection unit of the first local area network using the address of the second connection unit stored in an address storage unit connected to an external network connected with the first connection unit to store the address of the second connection unit;

a unit for accepting a command from the user to display a list of remote contents held by a predetermined device in the second local area network and outputting a remote content list acquisition request to the second connection unit;

a unit for receiving, from the second connection unit, remote content list data including, for each remote content, location information containing a remote content identifier and a hash value indicating the completion of authentication and indicating the location of the remote content on the one hand and the name of the remote content on the other hand, and storing the remote content list data in a content information storage unit;

a unit for displaying a list of the content names included in the remote content list data stored in the content information storage unit; and

a unit for accepting, from the user, a reproduction command including the designation of the remote content to be reproduced and outputting, to the reproduction unit, a reproduction request containing the address of the second connection unit stored in the address storage unit and the location information of the remote content to be reproduced, stored in the content information storage unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### DESCRIPTION OF EMBODIMENTS

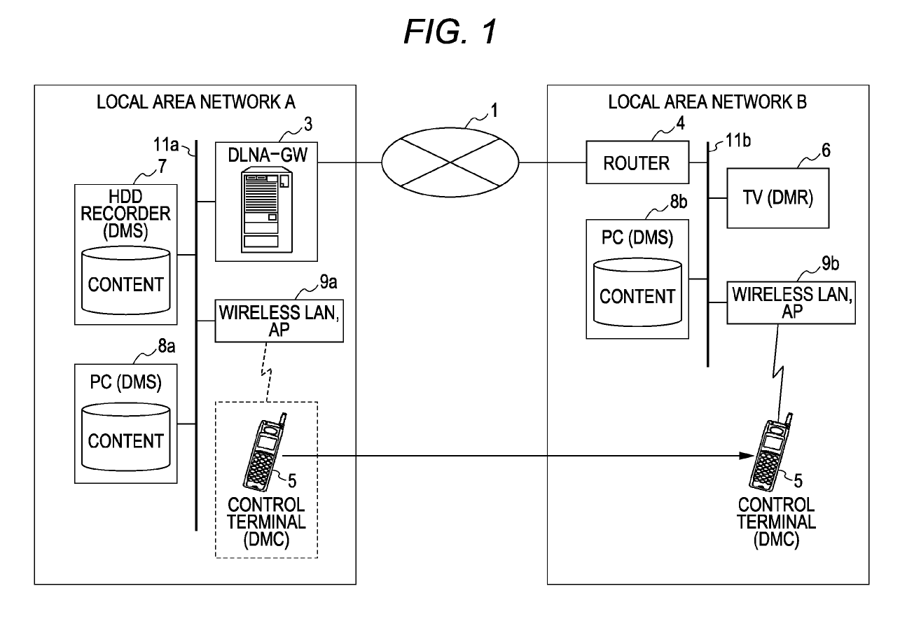

FIG. 1 depicts an outline of the system according to an embodiment. An interface 11a such as Ethernet (registered trademark) is connected with a DLNA-GW 3, an HDD recorder 7, a PC 8a and an access point (AP) 9a of a wireless LAN (local area network) to construct a local area network A (hereinafter sometimes referred to as LAN-A). On the other hand, an interface 11b of Ethernet or the like is connected with a router 4, a TV 6, a PC 8b and an access point 9b of a wireless LAN to construct a local area network B. The DLNA-GW 3 in the local area network A and the router 4 in the local area network B are connected to each other through a network 1 such as the internet. Incidentally, this embodiment assumes that the local area network A is the network of the user's home and the local area network B is the network of the home of a friend of the user. Also, the control terminal 5 (including a personal computer or a PDA (personal digital assistance) as well as a mobile phone) is owned by the user, and as long as it is located in the user's home, connected to the local area network A through the access point 9a. In the case where the user visits the friend's home, on the other hand, the control terminal 5 is connected to the local area network B through the access point 9b. Assume that the control terminal 5, the TV 6, the HDD recorder 7 and the PC 8 (8a and 8b in FIG. 1) are devices adapted for DLNA, and as depicted in FIG. 1, the control terminal 5 makes up a DMC, the TV 6 a DMR, and each of the HDD recorder 7 and the PC 8 a DMS. Although only one control terminal 5 is depicted in FIG. 1, two or more control terminals 5 may be used.

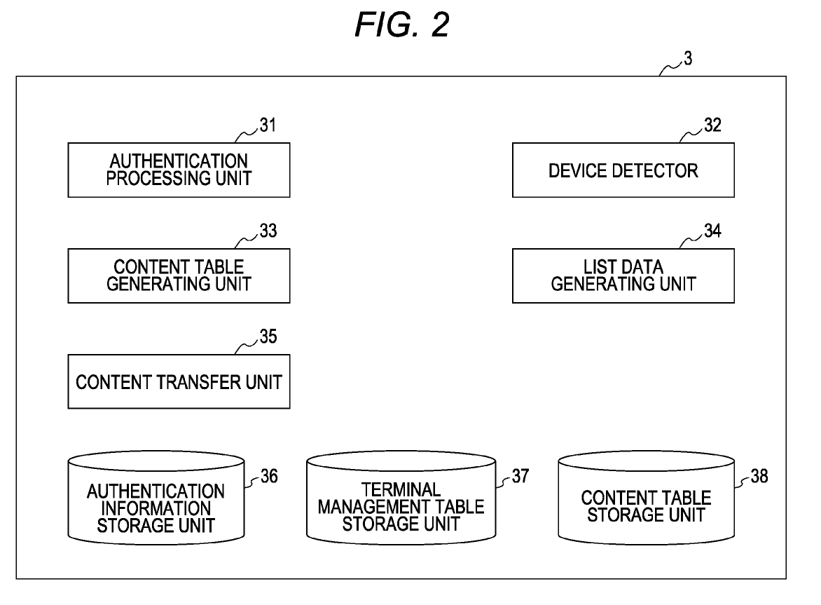

FIG. 2 is a function block diagram of the DLNA-GW 3 depicted in FIG. 1. The DLNA-GW 3 includes an authentication processing unit 31 for executing the authentication process in accordance with a request from the control terminal 5, a device detector 32 for detecting a device connected to the same local area network (LAN-A in FIG. 1), a content table generating unit 33 for collecting the content information from the device detected by the device detector 32 and generating a content table described later, a list data generating unit 34 for generating content list data, described later, in accordance with a request from the control terminal 5, a content transfer unit 35 for transferring the content data transmitted from a device connected to the local area network (LAN-A in FIG. 1) associated therewith to the reproduction unit connected to another local area network (LAN-B in FIG. 1), an authentication information storage unit 36 for storing the data used in the authentication process, a terminal management table storage unit 37 for storing a terminal management table described later, and a content table storage unit 38 for storing the content table generated by the content table generating unit 33.

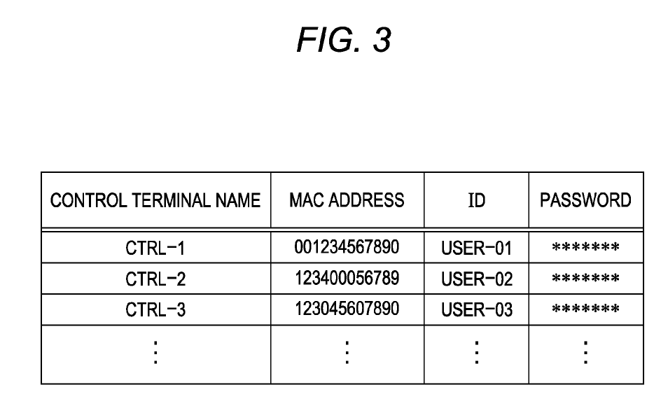

FIG. 3 depicts an example of the data stored in the authentication information storage unit 36. In the case of FIG. 3, the authentication information storage unit 36 contains a control terminal name column, a MAC address column, a user ID column and a password column.

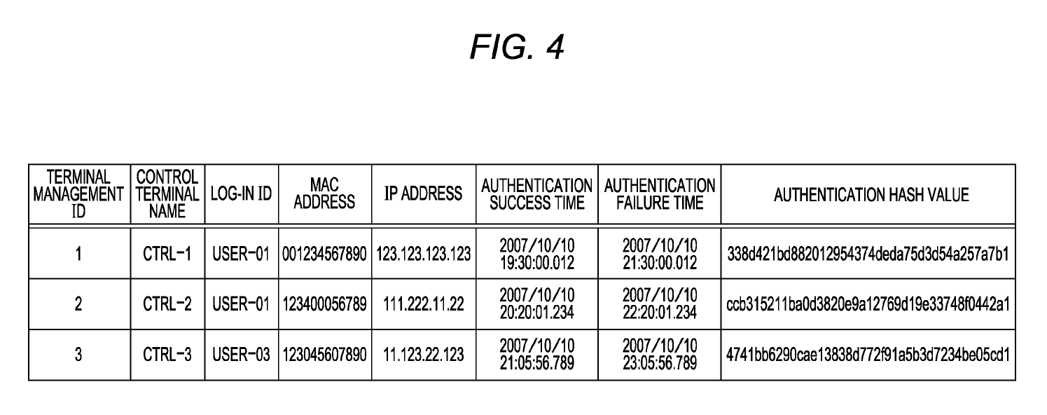

FIG. 4 depicts an example of the terminal management table stored in the terminal management table storage unit 37. In the case of FIG. 4, the terminal management table contains a terminal management ID column, the control terminal name column, a log-in ID column, the MAC address column, an IP address column, an authentication success time column, an authentication failure time column and an authentication hash value column. Incidentally, though explained later, once the authentication succeeds, a record is added to the terminal management table. The names of the control terminals 5 that have been authenticated and the MAC addresses are set in the control terminal name column and the MAD address column, respectively. The user IDs input at time of authentication are set in the log-in ID column. The IP address of each connecting device (such as the router) in the local area network connected with the control terminal 5 for the record is set in the IP address column. The time at which a hash value set in the authentication hash value column becomes invalid is set in the authentication failure time column.

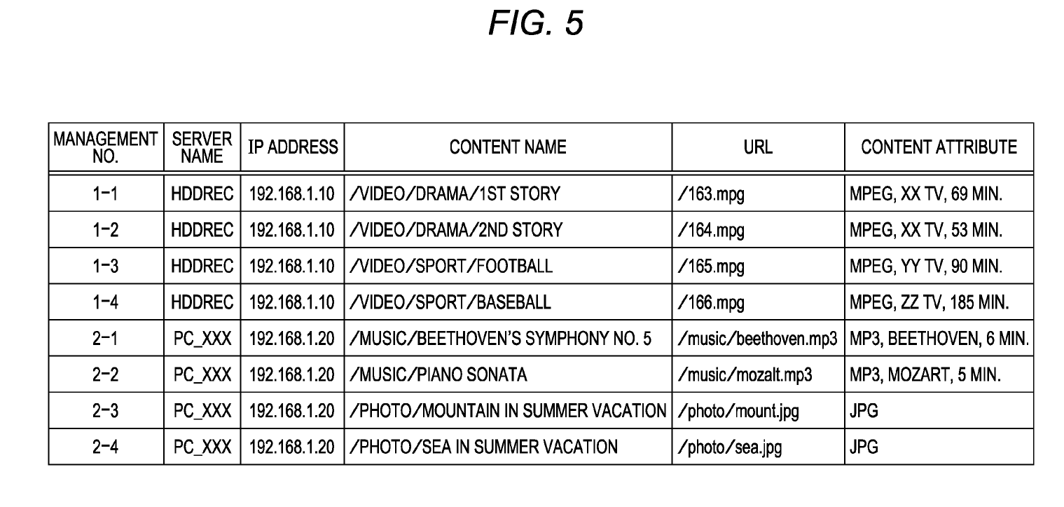

FIG. 5 depicts an example of the content table stored in the content table storage unit 38. In the case of FIG. 5, the content table includes a management number column, a server name column, the IP address column, a content name column, a URL column and a content attribute column. Each unique number capable of specifying the content is set in the management number column. Each name and the IP address of the server (DMS) holding the content are set in the server name column and the IP address column, respectively. The name of the content (including the directory name in the case where a plurality of directories are in tiers) is set in the content name column. The URL of the content is set in the URL column. This URL is designated to acquire the content from the DMS. Incidentally, the URL may include both the directory name and the file name (for example, “/photo/see.jpg”) or only the file name (for example, “/163.mpg”). The directory name, if included in the content name, is not necessarily included in the URL. This depends on the package of the DMS. The content type (MPEG, JPEG, MP3, etc.), the author, the recording time, etc. are set in the content attribute column.

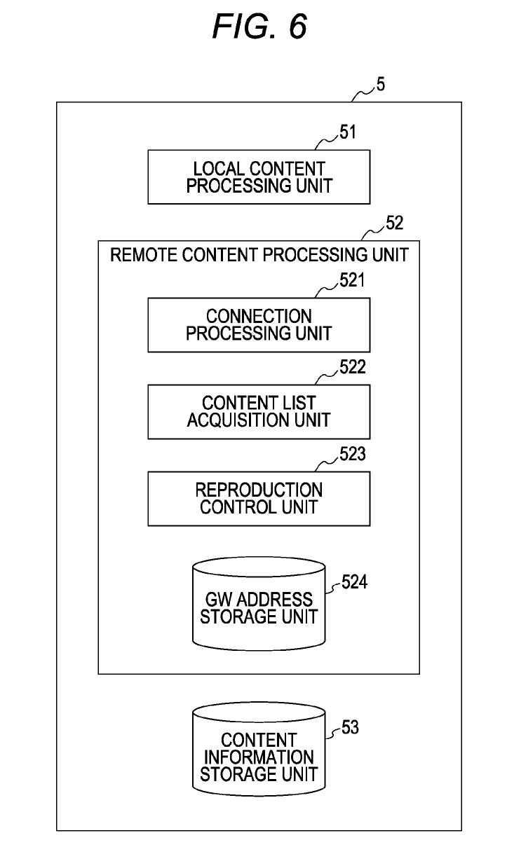

FIG. 6 depicts a function block diagram of the control terminal 5 of FIG. 1. The control terminal 5 includes a local content processing unit 51 for executing the process on the content (hereinafter sometimes referred to as the local content) held by the device connected currently to the local area network, a remote content processing unit 52 for executing the process on the content (hereinafter sometimes referred to as the remote content) held by the device connected to the local area network other than the currently-connected one, and a content information storage unit 53 for storing the local content information and the remote content information separately from each other.

The remote content processing unit 52 includes a connection processing unit 521 for executing the process to connect to the DLNA-GW 3, a content list acquisition unit 522 for acquiring the content list data from the DLNA-GW 3, a reproduction control unit 523 for outputting a command to the reproduction unit to reproduce the remote content, and a GW address storage unit 524 for storing the IP address of the DLNA-GW 3 and the hash value transmitted when the authentication succeeds.

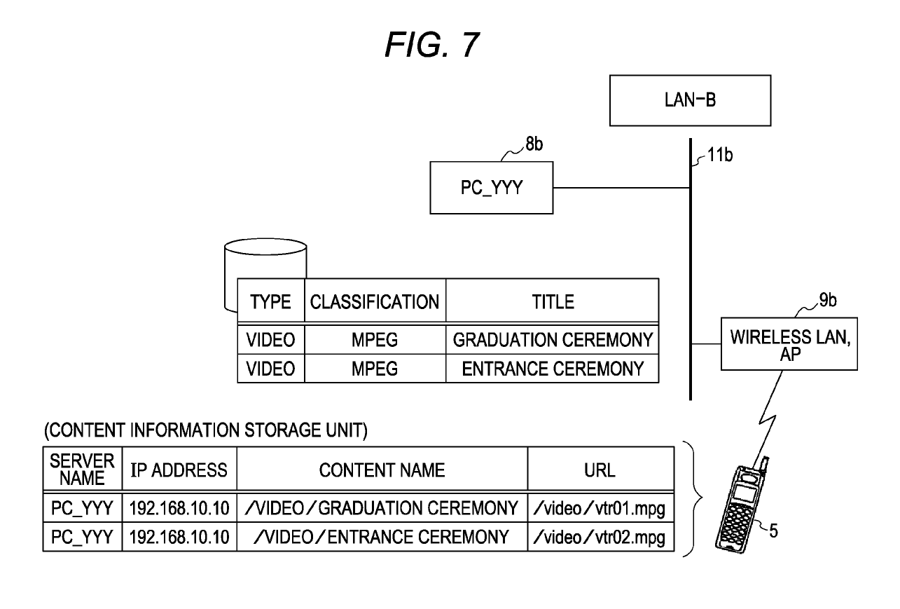

In the control terminal 5, the data as depicted in FIG. 7, for example, is stored as the local content information in the content information storage unit 53. Incidentally, FIG. 7 depicts a case in which the control terminal 5 is connected to the local area network B and the local content processing unit 51 has acquired the content information from the PC 8b (“PC_YYY” in server name). The process in the local content processing unit 51 is similar to the conventional process. In the case of FIG. 7, the local content information includes the server name, the IP address, the content name and the URL.

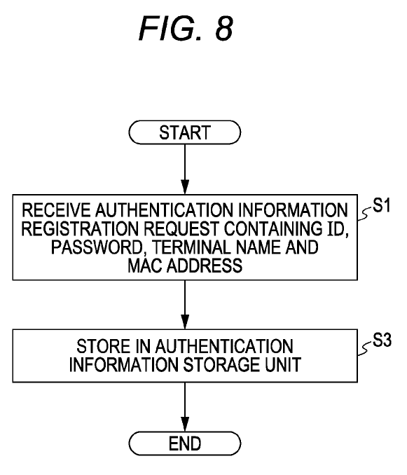

Next, the process executed by the system depinted in FIG. 1 will be explained with reference to FIGS. 8 to 21. Incidentally, this embodiment assumes a case in which the user carrying the control terminal 5 visits the home of a friend (LAN-B), and using the control terminal 5, acquires the list of the contents held in the devices (the HDD recorder 7, the PC 8a) of the user's home (LAN-A) and issues a command to the TV 6 of the friend's home to reproduce the contents.

First, the preliminary process of registering the authentication information will be explained with reference to FIG. 8. The control terminal 5 is connected to the local area network A and detects the DLNA-GW 3 by the UPnPDA function in the user's home. In the process, the IP address of the DLNA-GW 3 is stored in the GW address storage unit 524 of the control terminal 5. The user accesses the authentication information registration page of the DLNA-GW 3 by operating the control terminal 5. The user inputs the ID and the password on the authentication information registration screen (not depicted) displayed on the display unit of the control terminal 5.

The control terminal 5 accepts the input of the ID and the password and transmits an authentication information registration request including the input ID and the password together with the terminal name and the MAC address stored in a storage unit to the DLNA-GW 3. The authentication processing unit 31 of the DLNA-GW 3 receives the authentication information registration request including the ID, the password, the terminal name and the MAC address from the control terminal 5 (step S1 in FIG. 8). Then, the authentication processing unit 31 of the DLNA-GW 3 stores, in the authentication information storage unit 36, the ID, the password, the terminal name and the MAC address included in the authentication information registration request thus received (step S3). The process up to this step is executed before the user visits the friend's home.

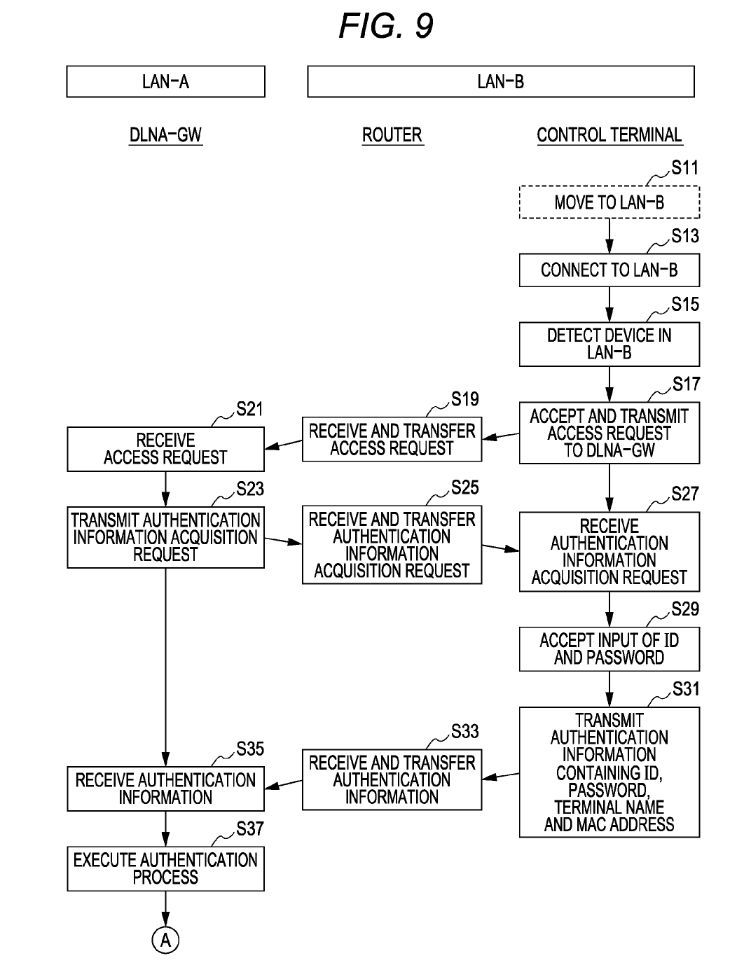

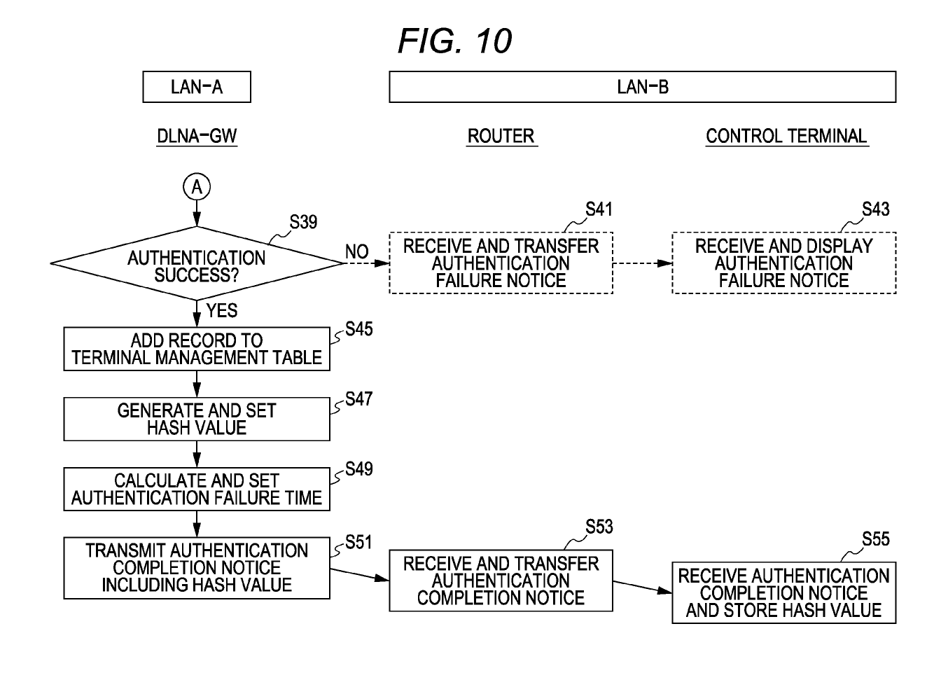

Next, the process executed after the user visits the friend's home will be explained. First, with reference to FIGS. 9 and 10, the authentication process executed between the DLNA-GW 3 and the control terminal 5 will be explained. For example, the user carrying the control terminal 5 moves to the friend's home (LAN-B) (step S11 in FIG. 9). This step is performed by the user, and therefore, indicated by dotted block in FIG. 9. The local content processing unit 51 of the control terminal 5 is then connected to the local area network B (step S13). The local content processing unit 51 of the control terminal 5, due to the UPnPDA function, detects the devices (the router 4, the TV 6 and the PC 8b) connected to the local area network B (step S15).

The user operates the control terminal 5 and inputs a command to access the DLNA-GW 3. The connection processing unit 521 of the control terminal 5 accepts the input of the command to access the DLNA-GW 3 and transmits an access request to the DLNA-GW 3 (step S17). In the process, the connection processing unit 521 of the control terminal 5 uses the IP address of the DLNA-GW 3 stored in the GW address storage unit 524. The router 4 receives the access request from the control terminal 5 and transfers it to the DLNA-GW 3 (step S19).

The authentication processing unit 31 of the DLNA-GW 3 receives the access request from the control terminal 5 (step S21), and transmits an authentication information acquisition request to the control terminal 5 (step S23). The router 4 receives the authentication information acquisition request from the DLNA-GW 3 and transfers it to the control terminal 5 (step S25).

The connection processing unit 521 of the control terminal 5 receives the authentication information acquisition request from the DLNA-GW 3 (step S27), and displays the input screen (not depicted) for the ID and the password on the display unit of the control terminal 5. After that, the user inputs the ID and the password on the input screen. The connection processing unit 521 of the control terminal 5 then accepts the input of the ID and the password from the user (step S29), and transmits, to the DLNA-GW 3, the authentication information including the ID and the password thus input and the terminal name and the MAC address stored in the storage unit (step S31). The router 4 receives the authentication information from the control terminal 5 and transfers it to the DLNA-GW 3 (step S33).

The authentication processing unit 31 of the DLNA-GW 3 receives the authentication information from the control terminal 5 and stores it provisionally in a storage unit (step S35). In the process, the IP address of the router 4 is stored in the storage unit together with the authentication information. The authentication processing unit 31 of the DLNA-GW 3 executes the authentication process using the authentication information stored in the storage unit and the data stored in the authentication information storage unit 36 (step S37). Specifically, in the authentication processing unit 31 of the DLNA-GW 3, the ID, the password, the terminal name and the MAC address contained in the authentication information stored in the storage unit are compared with the ID, the password, the control terminal name and the MAC address stored in the authentication information storage unit 36 thereby to judge whether any record coinciding in all respects is stored or not in the authentication information storage unit 36. After that, the process proceeds to step S39 (FIG. 10) through the terminal A.

Referring to FIG. 10, in the process after passing through the terminal A, the authentication processing unit 31 of the DLNA-GW 3 judges whether the authentication has succeeded or not (step S39 in FIG. 10). In the case where the authentication has failed (NO in step S39), the authentication processing unit 31 of the DLNA-GW 3 transmits an authentication failure notice to the control terminal 5. The router 4 receives the authentication failure notice from the DLNA-GW 3 and transfers it to the control terminal 5 (step S41). The connection processing unit 521 of the control terminal 5 receives the authentication failure notice from the DLNA-GW 3 and displays it on the display unit (step S43).

In the case where the authentication succeeds (YES in step S39), on the other hand, the authentication processing unit 31 of the DLNA-GW 3 adds the record to the terminal management table (step S45). In the process, the terminal name contained in the authentication information is set in the control terminal name column of the record by the authentication processing unit 31 of the DLNA-GW 3. Also, the ID contained in the authentication information is set in the log-in ID column. Further, the MAC address contained in the authentication information is set in the MAC address column, and the IP address of the router 4 stored in the storage unit is set in the IP address column. Furthermore, the time at which the authentication process is executed is set in the authentication success time column.

The authentication processing unit 31 of the DLNA-GW 3 generates a hash value indicating that the authentication has been finished, and sets the particular hash value in the authentication hash value column of the record added in step S45 (step S47). Also, the authentication processing unit 31 of the DLNA-GW 3 calculates the authentication failure time by adding a predetermined time (two hours, for example) to the authentication success time, and sets the calculated authentication failure time in the authentication failure time column of the record added in step S45 (step S49). After that, the authentication processing unit 31 of the DLNA-GW 3 transmits an authentication completion notice including the hash value calculated in step S47 to the control terminal 5 (step S51). The router 4 receives the authentication completion notice from the DLNA-GW 3 and transfers it to the control terminal 5 (step S53).

The connection processing unit 521 of the control terminal 5 receives the authentication completion notice from the DLNA-GW 3, so that the hash value contained in the authentication completion notice is stored in the GW address storage unit 524 (step S55). Also, the connection processing unit 521 of the control terminal 5 displays an authentication completion screen on the display unit.

Even in the case where the authentication is completed by the process up to this stage and the control terminal 5 is connected to the local area network B, the communication with the DLNA-GW 3 is still possible.

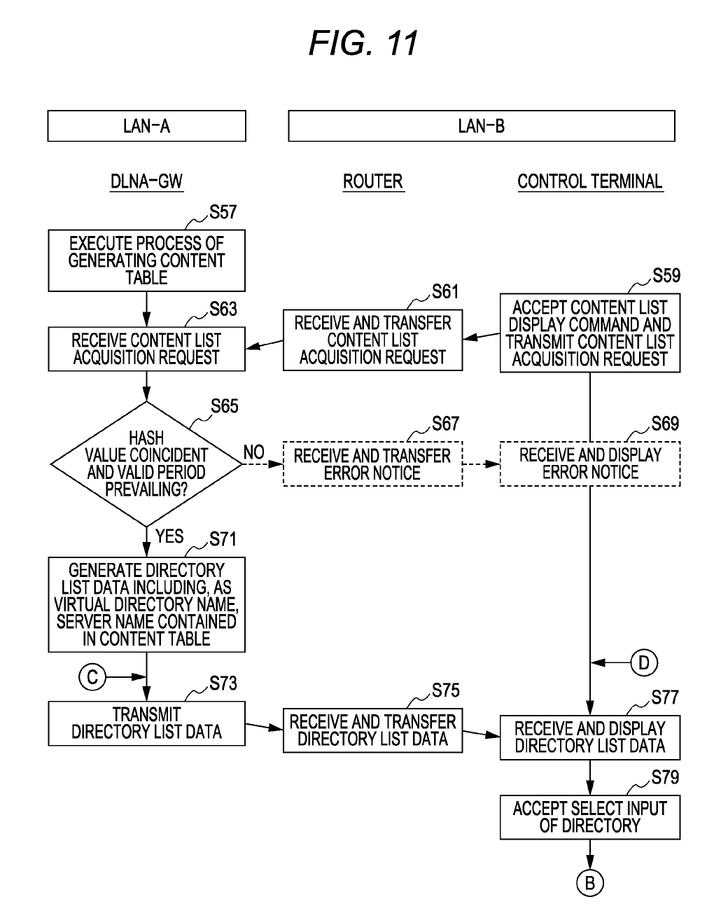

Next, the process for acquiring the content list data from the DLNA-GW 3 will be explained with reference to FIGS. 11 to 17. As a prerequisite, assume that the authentication process is completed as described above.

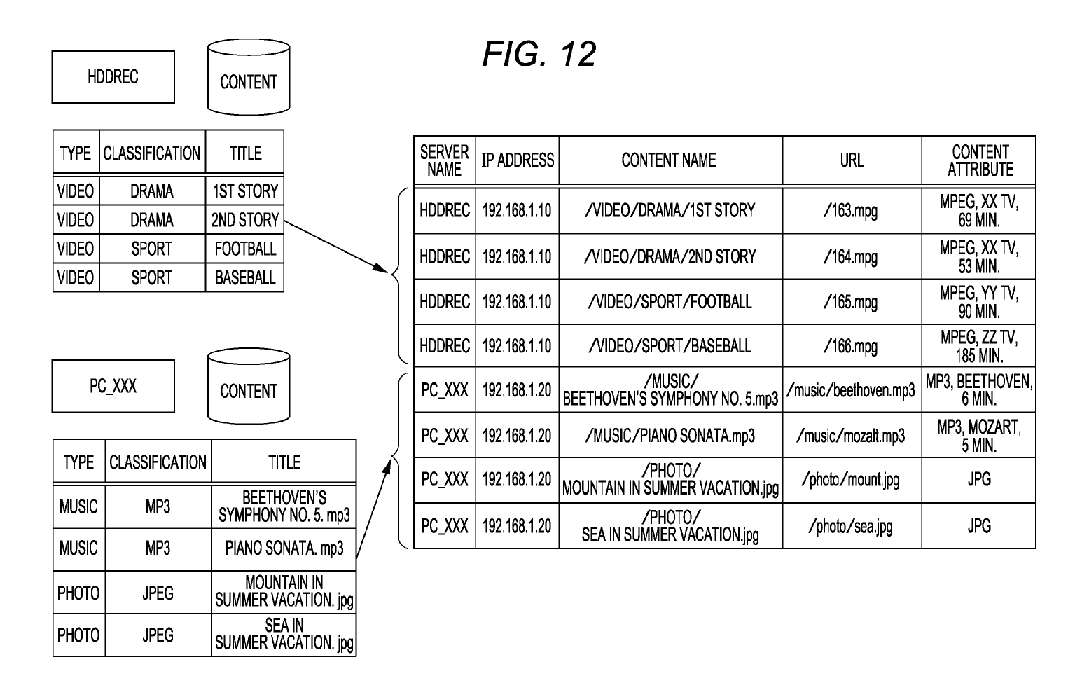

For example, the DLNA-GW 3 executes the content table generating process at an arbitrary timing (step S57 in FIG. 11). Specifically, first, the device detector 32 of the DLNA-GW 3 detects, by the UPnPDA function, a device connected to the local area network associated therewith. Then, the content table generating unit 33 of the DLNA-GW 3, as depicted in FIG. 12, for example, acquires the content information from the device (DMS) thus detected, and then generates the content table with the management number attached thereto. Incidentally, according to this embodiment, the management number is defined as “(number assigned for each DMS)—(number assigned for each content in the DMS)”. On the other hand, the user, by operating the control terminal 5, inputs a command to display the content list. The content list acquisition unit 522 of the control terminal 5 accepts the content list display command input by the user and transmits, to the DLNA-GW 3, a content list acquisition request including the MAC address, the hash value stored in the GW address storage unit 524 and the route directory designation (step S59). The router 4 receives the content list acquisition request from the control terminal 5 and transfers it to the DLNA-GW 3 (step S61).

The list data generating unit 34 of the DLNA-GW 3 receives the content list acquisition request from the control terminal 5 and stores it provisionally in a storage unit (step S63). The list data generating unit 34 of the DLNA-GW 3 extracts the MAC address and the hash value from the content list acquisition request, and searching the terminal management table based on the MAC address, specifies the record having a coincident MAC address. The list data generating unit 34 then judges whether the hash value extracted from the content list acquisition request coincides with the authentication hash value contained in the specified record, and in the case where it so coincides, judges whether the valid period is prevailing or not (step S65), that is, whether the valid period has expired. Whether the valid period is prevailing or not is judged based on the authentication failure time. Upon judgment that the hash value is incoincident or the valid period is not prevailing (NO in step S65), the list data generating unit 34 of the DLNA-GW 3 transmits an error notice to the control terminal 5. The router 4 receives the error notice from the DLNA-GW 3 and transfers it to the control terminal 5 (step S67). The content list acquisition unit 522 of the control terminal 5 receives the error notice from the DLNA-GW 3 and displays it on the display unit (step S69).

Upon judgment that the hash value is coincident or the valid period prevails (YES in step S65), on the other hand, the list data generating unit 34 of the DLNA-GW 3 generates directory list data containing, as a virtual directory name, the server name contained in the content table (step S71). This is in order to publish the presence of two directories, “HDDREC” and “PC_XXX” under the route directory to the control terminal 5, for example, in the case where the data depicted in FIG. 5 is stored in the content table. The list data generating unit 34 of the DLNA-GW 3 transmits the generated directory list data to the control terminal 5 (step S73). The router 4 receives the directory list data from the DLNA-GW 3 and transfers it to the control terminal 5 (step S75).

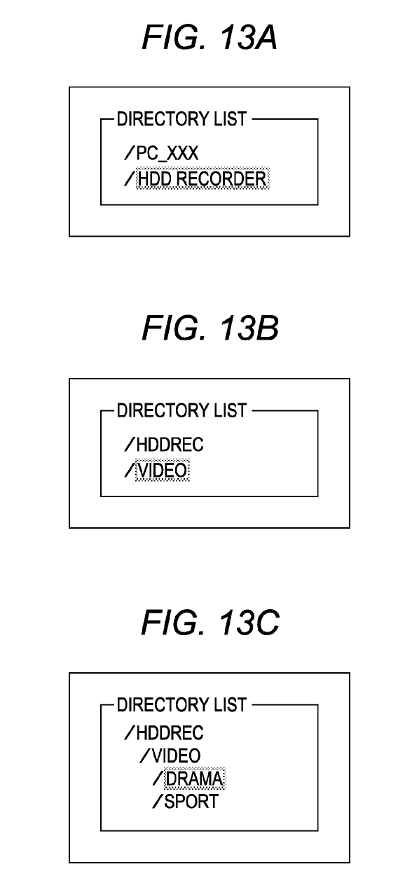

The content list acquisition unit 522 of the control terminal 5 receives the directory list data from the DLNA-GW 3 and displays the directory list screen on the display unit (step S77). The directory list screen as depicted in FIG. 13A, for example, is displayed.

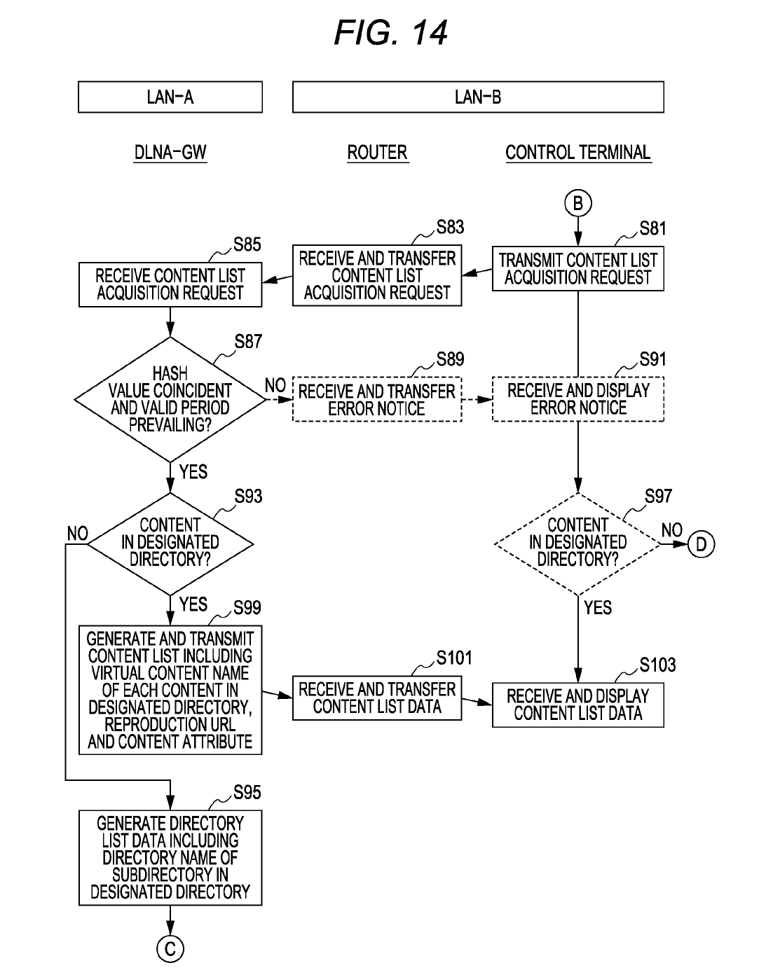

After that, the user selects any one of the directories by operating the control terminal 5 on the content list screen. The content list acquisition unit 522 of the control terminal 5 accepts the directory select input from the user (step S79). Then, the process proceeds to step S81 (FIG. 14) through the terminal B.

Now, referring to FIG. 14, after the process passes through the terminal B, the content list acquisition unit 522 of the control terminal 5 transmits, to the DLNA-GW 3, a content list acquisition request containing the MAC address, the hash value stored in the GW address storage unit 524 and the selected directory designation (step S81 in FIG. 14). The router 4 receives the content list acquisition request from the control terminal 5 and transfers it to the DLNA-GW 3 (step S83).

The list data generating unit 34 of the DLNA-GW 3 receives the content list acquisition request from the control terminal 5 and stores it provisionally in a storage unit (step S85). The list data generating unit 34 of the DLNA-GW 3 then extracts the MAC address and the hash value from the content list acquisition request, and by searching the terminal management table based on the MAC address, specifies a record coincident in MAC address. The list data generating unit 34 of the DLNA-GW 3 judges whether the hash value extracted from the content list acquisition request is coincident with the authentication hash value contained in the specified record, and in the case where it is so coincident, further judges whether the valid period prevails or not (step S87). Incidentally, whether the valid period prevails or not is judged based on the authentication failure time. Upon judgment that the hash value is incoincident or the valid period is not prevailing (NO in step S87), the list data generating unit 34 of the DLNA-GW 3 transmits an error notice to the control terminal 5. The router 4 receives the error notice from the DLNA-GW 3 and transfers it to the control terminal 5 (step S89). The content list acquisition unit 522 of the control terminal 5 receives the error notice from the DLNA-GW 3 and displays it on the display unit (step S91).

Upon judgment that the hash value is coincident and the valid period prevails (YES in step S87), on the other hand, the list data generating unit 34 of the DLNA-GW 3 accesses the content table and judges whether the content exists in the directory designated by the content list acquisition request (step S93). Upon judgment that the content is not existing in the directory designated by the content list acquisition request (NO in step S93), the list data generating unit 34 of the DLNA-GW 3 generates directory list data containing the directory name of a subdirectory in the directory designated by the content list acquisition request (step S95). After that, the process returns to step S73 (FIG. 11) through the terminal C. Upon judgment that the content is not existent in the directory designated by the content list acquisition request (NO in step S97), the control terminal 5 returns to the process of step S77 (FIG. 11) through the terminal D. The judgment in step S97 is not the process executed by the control terminal 5, and therefore, designated by dotted block in FIG. 14. The process of steps S73 to S95 is repeated until the judgment is reached that the content exists in the directory designated by the content list acquisition request.

In the case where the directory “HDDREC” is selected on the directory list screen depicted in FIG. 13A, for example, the directory list screen as depicted in FIG. 13B is displayed on the display unit of the control terminal 5. Further, in the case where the directory “VIDEO” is selected on the directory list screen depicted in FIG. 13B, the directory list screen as depicted in FIG. 13C is displayed on the display unit of the control terminal 5. In the case where a hierarchical structure is formed by a plurality of directories as described above, the directory selection process is continued until the target content is found.

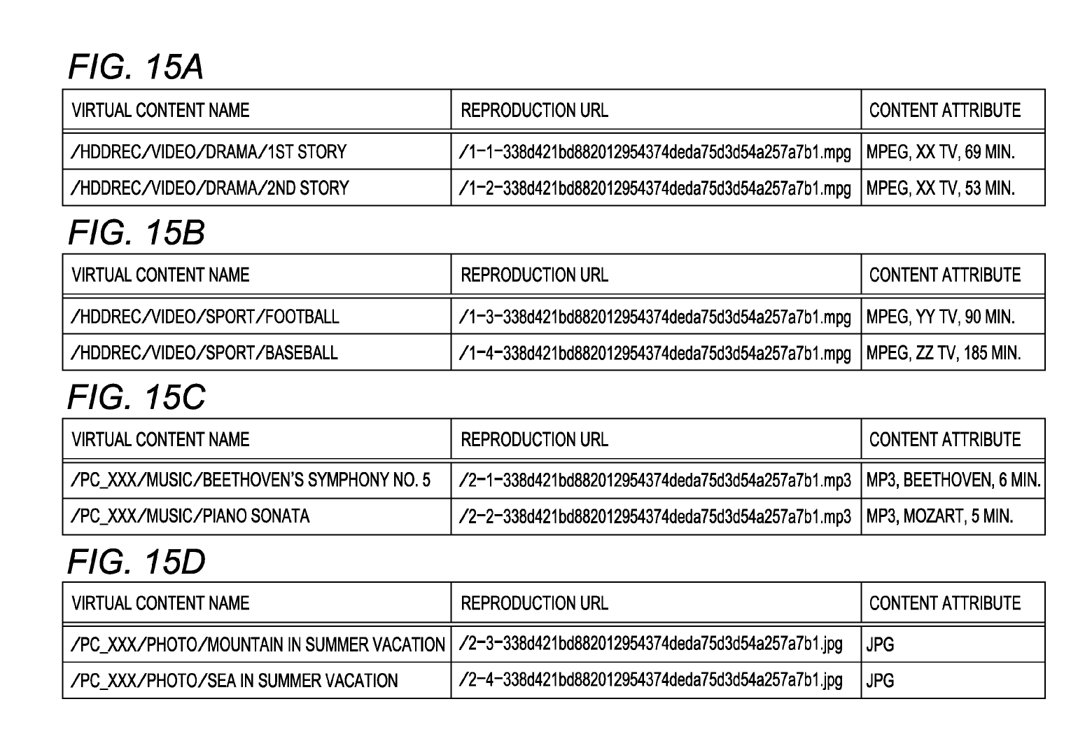

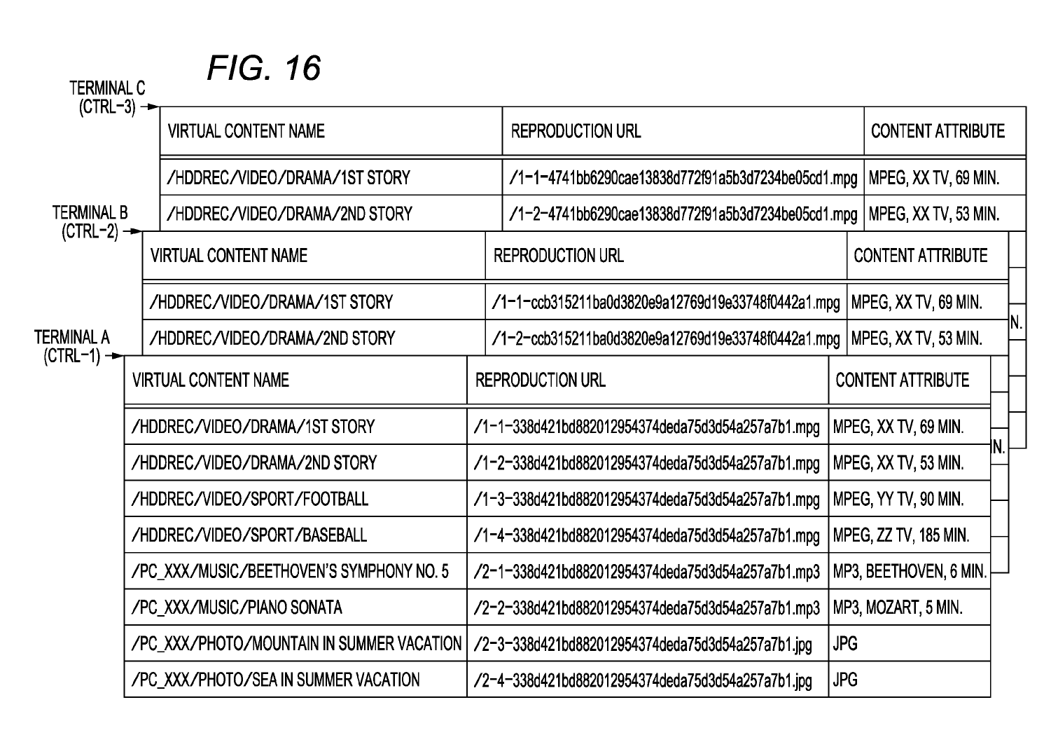

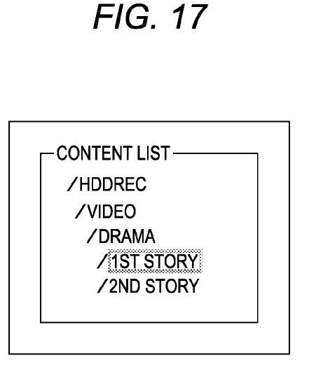

Upon judgment in step S93 that the content exists in the directory designated by the content list acquisition request (YES in step S93), on the other hand, the list data generating unit 34 of the DLNA-GW 3 generates content list data including the virtual content name, the URL for reproduction (hereinafter referred to as the reproduction URL) and the content attribute of each content in the directory designated by the content list acquisition request, and transmits the content list data thus generated to the control terminal 5 (step S99). The list data generating unit 34 of the DLNA-GW 3 generates the content list data as depicted in FIGS. 15A to 15D. Incidentally, FIG. 15A depicts the content list data with the directory “VIDEO” designated by the content list acquisition request. Also, FIG. 15B depicts the content list data with the directory “SPORT” designated by the content list acquisition request. Further, FIG. 15C depicts the content list data with the directory “MUSIC” designated by the content list acquisition request. FIG. 15D depicts the content list data with the directory “PHOTO” designated by the content list acquisition request. The virtual content name is generated by coupling the server name and the content name in the content table. The reproduction URL is generated by coupling the management number in the content table with the authentication hash value and the extension in the terminal management table. The content list data thus generated is stored in a storage unit. Also, in the case where a plurality of control terminals 5 make an access, the content list data is generated for each terminal as depicted in FIG. 16. As depicted in FIG. 16, the virtual content and the content attribute are identical but the reproduction URL is varied for each terminal.

The router 4 receives the content list data from the DLNA-GW 3 and transfers it to the control terminal 5 (step S101). Upon judgment that the content exists in the directory designated by the content list acquisition request (YES in step S97), the content list acquisition unit 522 of the control terminal 5 receives the content list data from the DLNA-GW 3 and stores it in the content information storage unit 53 while at same time displaying the content list screen on the display unit (step S103). The content list screen as depicted in FIG. 17, for example, is displayed on the display unit.

Even in the case where the control terminal 5 is connected to the local area network B, therefore, the content list held in the devices connected to the local area network A can be accessed by executing the aforementioned process. Incidentally, the acquisition of the content list data from the DLNA-GW 3 requires the advance authentication, and therefore, hardly poses the security problem.

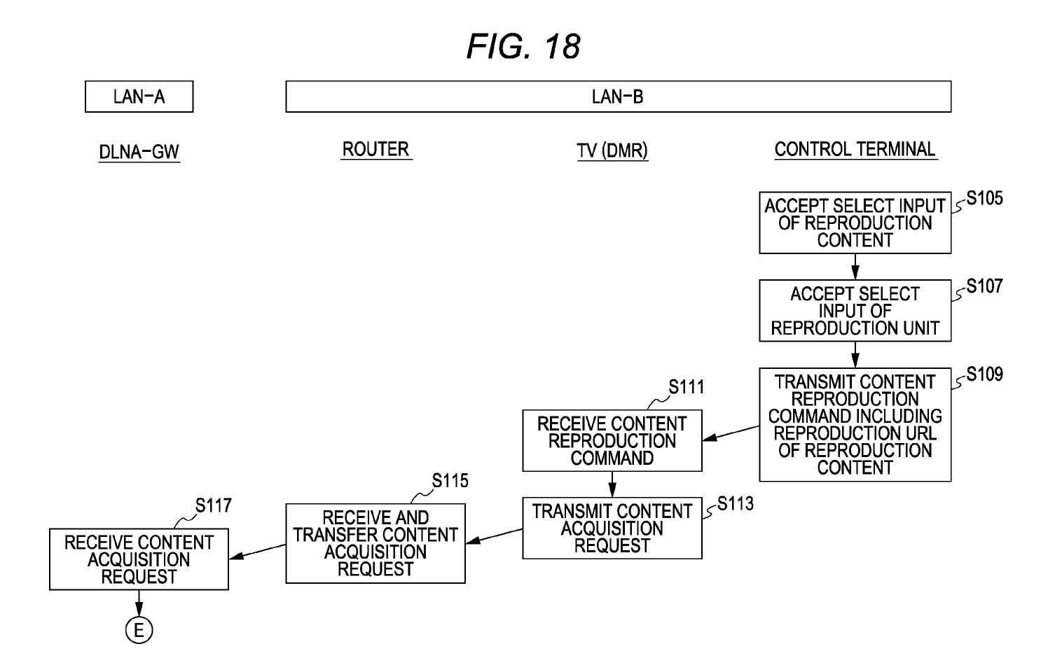

Next, with reference to FIGS. 18 to 21, the process will be explained in which the content held by the DMS (HDD recorder 7 or PC 8a in FIG. 1) connected to the local area network A is reproduced by the DMR (TV 6 in FIG. 1) connected to the local area network B. Incidentally, assume as a prerequisite that the content list data has been acquired from the DLNA-GW 3.

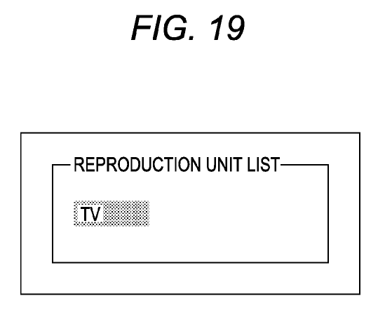

In the content list screen (FIG. 17) displayed on the display unit of the control terminal 5, for example, the user selects the content to be reproduced. The reproduction control unit 523 of the control terminal 5 accepts the select input of the content to be reproduced (step S105 in FIG. 18), and displays the reproduction unit list screen on the display unit as depicted in FIG. 19. Incidentally, a DMR list is displayed on the reproduction unit list screen. After that, the user selects the reproduction unit from the reproduction unit list screen displayed on the display unit of the control terminal 5. The depicted case assumes that the TV 6 is selected. The reproduction control unit 523 of the control terminal 5 accepts the select input of the reproduction unit (step S107), and extracts the reproduction URL of the content to be reproduced from the content information storage unit 53 on the one hand and the IP address of the DLNA-GW 3 from the GW address storage unit 524 at the same time. The content reproduction command containing the reproduction URL and the IP address of the DLNA-GW 3 thus extracted is transmitted to the TV 6 by the reproduction control unit 523 of the control terminal 5 (step S109).

The TV 6 receives the content reproduction command from the control terminal 5 and stores it provisionally in a storage unit (step S111). The TV 6 transmits the content acquisition request containing the reproduction URL contained in the content reproduction command to the IP address of the DLNA-GW 3 (step S113). Incidentally, the TV 6 is similar in function to the conventional version. The router 4 receives the content acquisition request from the TV 6 and transfers it to the DLNA-GW 3 (step S115).

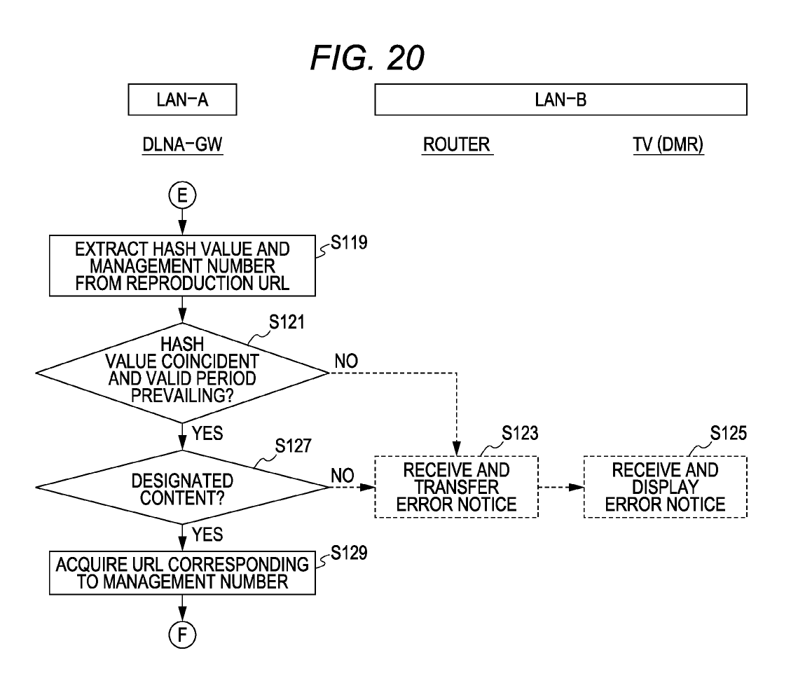

The content transfer unit 35 of the DLNA-GW 3 receives the content acquisition request from the TV 6 and stores it provisionally in a storage unit (step S117). After that, the process proceeds to step S119 (FIG. 20) through the terminal E.

Referring to FIG. 20, after the process passes through the terminal E, the content transfer unit 35 of the DLNA-GW 3 extracts the hash value and the management number from the reproduction URL contained in the content acquisition request (step S119 in FIG. 20). The content transfer unit 35 of the DLNA-GW 3 searches the terminal management table based on the IP address of the router 4, and thus specifies the record having a coincident IP address. Then, the content transfer unit 35 of the DLNA-GW 3 judges whether the hash value extracted from the reproduction URL is coincident with the authentication hash value contained in the specified record, and in the case of coincidence, further judges whether the valid period prevails (step S121). Upon judgment that the hash value fails to coincide or the valid period has expired (NO in step S121), the content transfer unit 35 of the DLNA-GW 3 transmits an error notice to the TV 6. The router 4 receives the error notice from the DLNA-GW 3 and transfers it to the TV 6 (step S123). The TV 6 receives the error notice from the DLNA-GW 3, and displays it (step S125).

Upon judgment that the hash value is coincident and the valid period prevails (YES in step S121), on the other hand, the content transfer unit 35 of the DLNA-GW 3 searches the content table based on the management number extracted from the reproduction URL, and judges whether there exists the content designated by the content acquisition request (step S127). Upon judgment that the content designated by the content acquisition request is not existent (NO in step S127), the content transfer unit 35 of the DLNA-GW 3 transmits an error notice to the TV 6. The router 4 receives the error notice from the DLNA-GW 3, and transfers it to the TV 6 (step S123). The TV 6 receives the error notice from the DLNA-GW 3 and displays it (step S125).

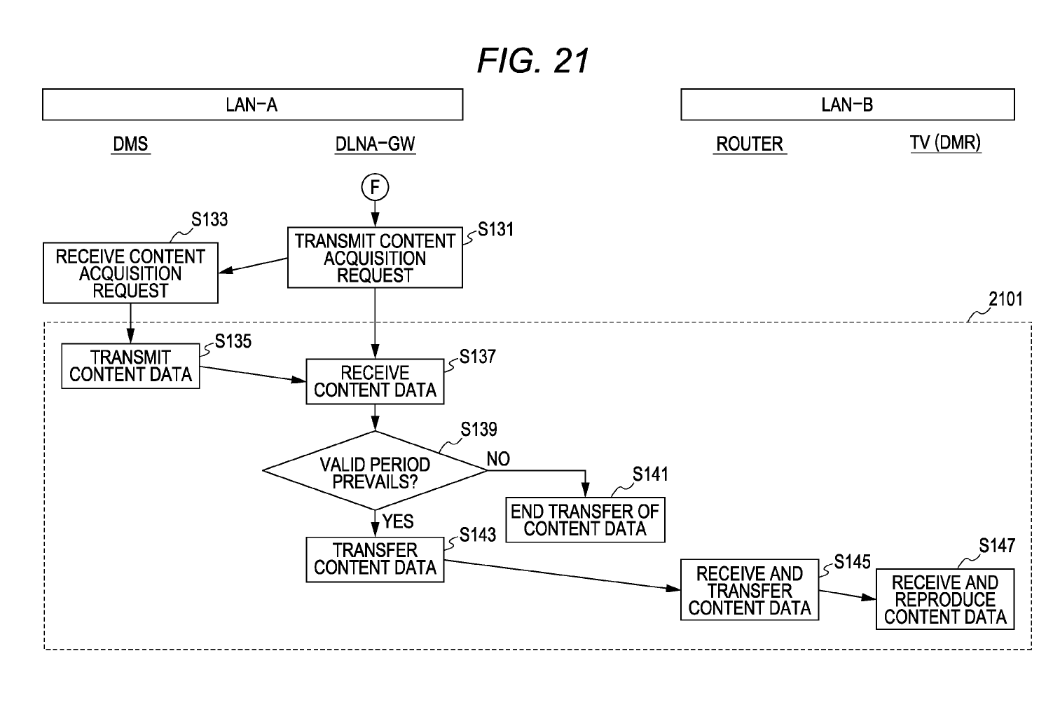

Upon judgment that the content designated by the content acquisition request is existent (YES in step S127), on the other hand, the content transfer unit 35 of the DLNA-GW 3 acquires, from the content table, the URL and the IP address corresponding to the management number extracted from the reproduction URL (step S129). After that, the process proceeds to step S131 (FIG. 21) through the terminal F.

Now, referring to FIG. 21, after the process is passed through the terminal F, the content transfer unit 35 of the DLNA-GW 3 transmits the content acquisition request containing the URL acquired from the content table to the ID address (DMS) acquired from the content table (step S131 in FIG. 21).

Then, the DMS receives the content acquisition request from the DLNA-GW 3 (step S133). Then, the DMS transmits the data on the content for the content acquisition request to the DLNA-GW 3 (step S135).

The content transfer unit 35 of the DLNA-GW 3 receives the content data from the DMS (step S137), and accessing the terminal management table, judges whether the valid period prevails or not (step S139). Upon judgment that the valid period is not prevailing (NO in step S139), the content transfer unit 35 of the DLNA-GW 3 ends the transfer of the content data (step S141). Upon judgment that the valid period prevails (YES in step S139), on the other hand, the content data is transferred to the TV 6 (step S143). The router 4 receives the content data from the DLNA-GW 3 and transfers it to the TV 6 (step S145). The TV 6 receives the content data and reproduces it on the display unit (step S147). The process of steps S136 to S147 (i.e. the process defined by the dotted frame 2101) is repeated until all the content data are reproduced.

By executing the process described above, the content held in the device (DMS) in the user's home can be reproduced by a reproduction device (DMR) in his/her friend's home. According to this embodiment, this function can be easily realized simply by installing the DLNA-GW 3 in the user's home for executing the process described above.

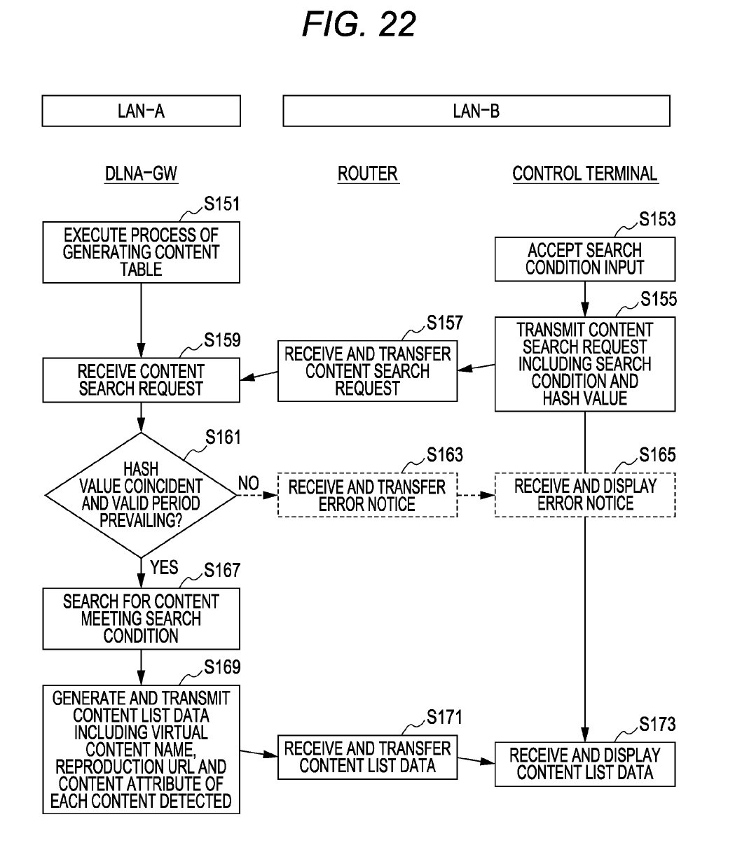

Next, the content search process will be explained with reference to FIGS. 22 to 24. Incidentally, assume that the authentication process described above is complete as a prerequisite.

The DLNA-GW 3, for example, executes the process of generating the content table at an arbitrary timing (step S151 in FIG. 22). This process is similar to the process of step S57 (FIG. 11), and therefore, not explained any more.

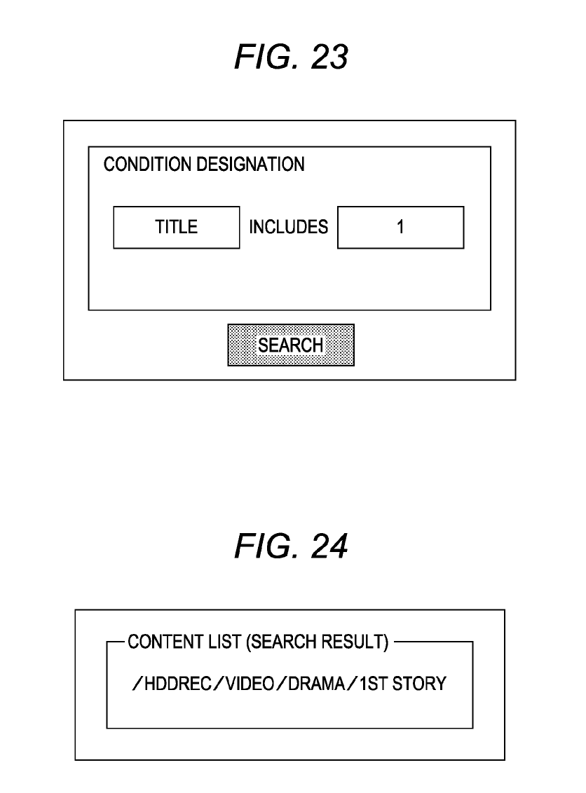

On the other hand, the user inputs the search condition from the search condition input screen (FIG. 23) displayed on the display unit of the control terminal 5. The content list acquisition unit 522 of the control terminal 5 accepts the input of the search condition from the user (step S153), and transmits a content search request including the input search condition, the MAC address and the hash value stored in the GW address storage unit 524 to the DLNA-GW 3 (step S155). The router 4 receives the content search request from the control terminal 5 and transfers it to the DLNA-GW 3 (step S157).

The list data generating unit 34 of the DLNA-GW 3 receives the content search request from the control terminal 5 and stores it provisionally in a storage unit (step S159). The list data generating unit 34 of the DLNA-GW 3 extracts the MAC address and the hash value from the content list acquisition request, and by searching the terminal management table based on the MAC address, specifies the record having a coincident MAC address. The list data generating unit 34 judges whether the hash value extracted from the content list acquisition request is coincident with the authentication hash value contained in the specified record, and in the case where they are coincident, further judges whether the valid period prevails or not (step S161). Upon judgment that the hash value is incoincident or the valid period is not prevailing (NO in step S161), the list data generating unit 34 of the DLNA-GW 3 transmits an error notice to the control terminal 5. The router 4 receives the error notice from the DLNA-GW 3 and transfers it to the control terminal 5 (step S163). The content list acquisition unit 522 of the control terminal 5 receives the error notice from the DLNA-GW 3 and displays it on the display unit (step S165).

Upon judgment that the hash value is coincident and the valid period prevails (YES in step S161), on the other hand, the list data generating unit 34 of the DLNA-GW 3 searches the content table for a content meeting the search condition (step S167). The list data generating unit 34 of the DLNA-GW 3 generates the content list data including the virtual content name, the reproduction URL and the content attribute of each detected content and transmits it to the control terminal 5 (step S169). Incidentally, the process of generating the content list data is similar to the process of step S99 (FIG. 14) and therefore not explained any further.

The router 4 receives the content list data from the DLNA-GW 3 and transfers it to the control terminal 5 (step S171). The content list acquisition unit 522 of the control terminal 5 receives the content list data from the DLNA-GW 3 and stores it in the content information storage unit 53 while at the same time displaying the content list screen on the display unit (step S173). The content list screen as depicted in FIG. 24, for example, is displayed on the display unit.

By executing the process described above, the target content can be easily found.

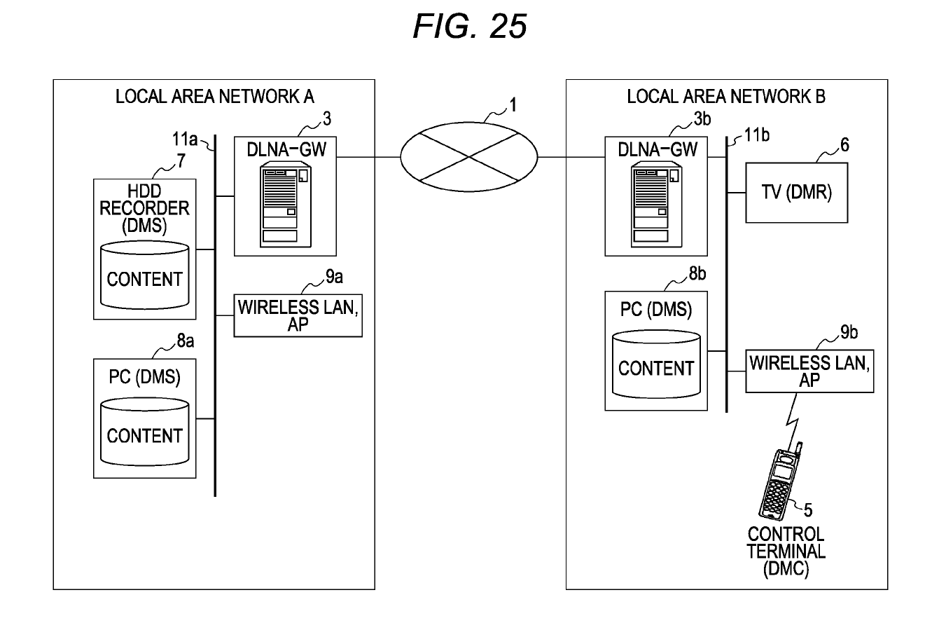

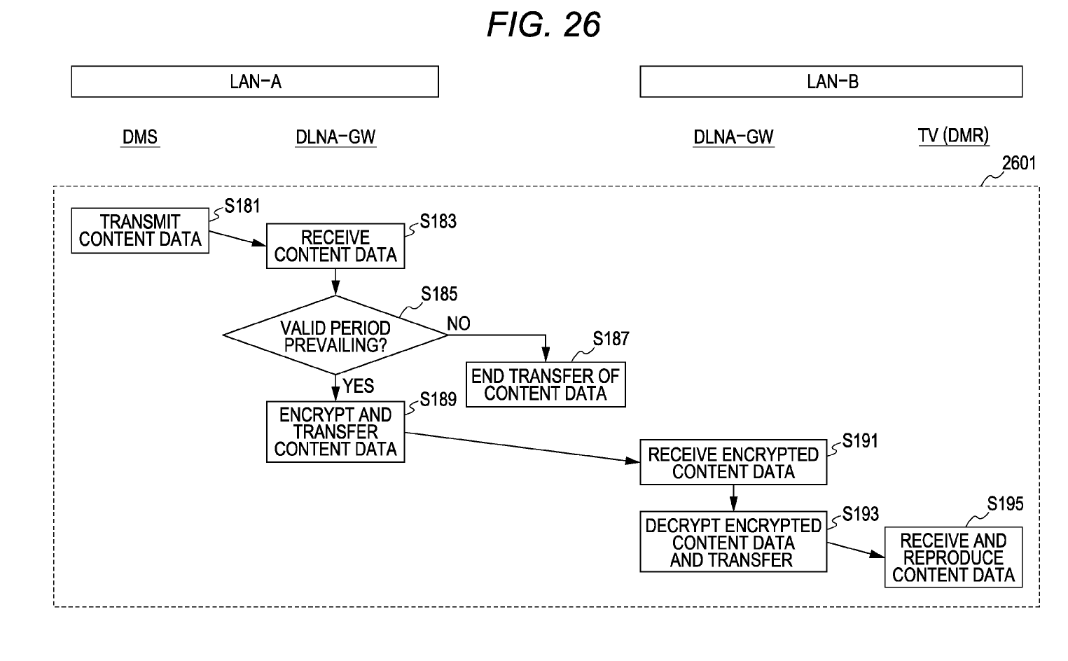

The invention is not limited to the embodiment described above. Although the foregoing description represents a case in which the DLNA-GW 3 is installed only in the user's home, a configuration may alternatively be employed in which the DLNA-GW 3 (designated by 3b in FIG. 25) is installed also in the friend's home as depicted in FIG. 25. In this case, the process depicted in FIG. 26 is executed in place of the process designated by dotted frame 2101 (FIG. 21) described above.

Specifically, the DMS transmits the data on the content for the content acquisition request, to the DLNA-GW 3 (step S181 in FIG. 26). The content transfer unit 35 of the DLNA-GW 3 receives the content data from the DMS (step S183), and by referring to the terminal management table, judges whether the valid period prevails or not (step S185). In the case where the valid period is not prevailing (NO in step S185), the content transfer unit 35 of the DLNA-GW 3 ends the transfer of the content data (step S187). Upon judgment that the valid period prevails (YES in step S185), on the other hand, the content data is encrypted and transferred to the TV 6 (step S189). The DLNA-GW 3b receives the encrypted content data from the DLNA-GW 3 (step S191) and decrypts and transfers the content data to the TV 6 (step S193). The TV 6 receives the content data and reproduces it on the display unit (step S195). The process of steps S181 to S195 (i.e. the process defined in dotted frame 2601) is repeated until all the content data are reproduced. By doing so, the security can be improved for transferring the content data.

Also, the function block diagram of the DLNA-GW 3 and the control terminal 5 described above do not necessarily correspond to the actual program module configuration. Further, the configuration of each table described above is only an example and not necessarily employed. Similarly, the screen described above is an example, and other screen configurations for displaying similar contents can be employed with equal effect. Furthermore, as long as the processing result remains unchanged, the order of process execution can be changed or the steps of the process can be executed in parallel in the processing flow.

The embodiment of the invention described above can be summarized into the aspects described below.

The portable terminal according to a first aspect is for instructing the reproduction unit capable of reproducing a content to reproduce the content. This portable terminal includes:

a unit for connecting to a first local area network connected with the reproduction unit;

a unit for accepting a command from the user to connect to a second local area network and connecting to a second connection unit of the second local area network through a first connection unit of the first local area network using the address of the second connection unit stored in an address storage unit connected to an external network connected with the first connection unit to store the address of the second connection unit;

a unit for accepting a command from the user to display a list of remote contents held by a predetermined device in the second local area network and outputting a remote content list acquisition request to the second connection unit;

a unit for receiving, from the second connection unit, remote content list data including, for each remote content, location information containing a remote content identifier and a hash value indicating the completion of authentication and indicating the location of the remote content on the one hand and the name of the remote content on the other hand, and storing the remote content list data in a content information storage unit;

a unit for displaying a list of the content names included in the remote content list data stored in the content information storage unit; and
a unit for accepting, from the user, a reproduction command including the designation of the remote content to be reproduced and outputting, to the reproduction unit, a reproduction request containing the address of the second connection unit stored in the address storage unit and the location information of the remote content to be reproduced, stored in the content information storage unit.

By doing so, the content held by a device connected to the second local area network (user's home, for example) can be easily reproduced by the reproduction device connected to the first local area network (friend's home, for example).

The content relay device according to a second aspect, associated with the second local area network, is connected to the connection unit of the first local area network through an external network. This content relay device includes:

a content table holding, for each content held by each predetermined device in the second local area network, an identifier, a content name, an address of a predetermined device holding the content and the first location information indicating the location of the content;

a unit for receiving authentication information from the control terminal of the first local area network to execute the authentication process;

a unit for calculating, if the authentication process succeeds, a hash value indicating the completion of authentication and storing the valid period of the hash value and the control terminal identifier in correspondence with each other in the terminal management table;

a location information generating unit which, upon reception of a content list acquisition request from the control terminal, generates second location information including an identifier of each content stored in the content table and the hash value stored in the terminal management table and corresponding to the control terminal at the transmitting end of the content list acquisition request;

a unit for generating content list data including, for each content, the second location information generated by the location information generating unit and the content name stored in the content table, and transmitting the content list data to the control terminal of the transmitting end of the content list acquisition request received by the location information generating unit;

a judgment unit which upon reception of a reproduction request transmitted from the reproduction unit of the first local area network and including the second location information of the content to be reproduced, extracts the hash value from the second location information contained in the reproduction request and judges whether the reception of the reproduction request is stored in the terminal management table and the valid period corresponding to the hash value prevails or not;

a unit which upon judgment that the reproduction request is received within the valid period, extracts the content identifier from the second location information contained in the reproduction request received by the judgment unit, acquires the first location information and the address of a predetermined device corresponding to the extracted content identifier from the content table, and outputs the content data acquisition request including the acquired first location information to the acquired address of the predetermined device; and

a unit which upon reception of the content data from the predetermined device having output the content data acquisition request, transmits the received content data to the reproduction unit at the transmitting end of the reproduction request received by the judgment unit.

By doing so, the content data can be acquired from a device connected to the second local area network (the user's home, for example) in accordance with the reproduction request from the reproduction unit connected to the first local area network (the home of the user's friend, for example) and can be transferred to the reproduction unit. Specifically, once the content relay device is installed in the user's home, the content held in the device in the user's home can be reproduced by the reproduction unit in the home of his/her friend. Also, the second location information contained in the reproduction request from the reproduction unit contains the hash value indicating the completion of authentication, and the content data is transferred to the reproduction unit in the case where the reproduction request is received within the valid period of the hash value. Therefore, the problem of security hardly occurs.

The remote content reproduction system according a third aspect includes a content relay device of the second local area network, connected to the connection unit of a first local area network through an external network and a portable terminal connected to the first local area network to instruct the reproduction unit of the first local area network to reproduce the content. The content relay device includes:

a content table for storing an identifier and a content name of each remote content held by each predetermined device in the second local area network, the address of the predetermined device holding the remote content and the first location information indicating the location of the remote content;

a unit for executing the authentication process in accordance with a connection request from the portable terminal;

a unit for calculating the hash value indicating the completion of authentication and storing the hash value in correspondence with the valid period of the hash value and the identifier of the portable terminal in a terminal management table in the case where the authentication process succeeds;

a location information generating unit which upon reception of a remote content list acquisition request from the portable terminal, generates second location information including the identifier of each remote content stored in the content table and the hash value stored in the terminal management table and corresponding to the portable terminal at the transmitting end of the remote content list acquisition request;

a unit for generating remote content list data containing, for each remote content, the second location information generated by the location information generating unit and the content name stored in the content table, and transmitting the remote content list data to the portable terminal at the transmitting end of the remote content list acquisition request received by the location information generating unit;

a judgment unit which upon reception of the reproduction request from the reproduction unit including the second location information of the remote content to be reproduced, extracts the hash value from the second location information contained in the reproduction request and judges whether the reception of the reproduction request is stored in the terminal management table and the valid period corresponding to the hash value prevails;

a unit which upon judgment that the reproduction request is received during the valid period, extracts the identifier of the remote content from the second location information included in the reproduction request received by the judgment unit, acquires from the content table the first location information and the address of the predetermined device corresponding to the identifier of the remote content extracted, and outputs the remote content data acquisition request including the acquired first location information to the acquired address of the predetermined device; and

a unit which upon reception of the remote content data from the predetermined device having output the remote content data acquisition request, transmits the received remote content data to the reproduction unit at the transmitting end of the reproduction request received by the judgment unit.

Further, the portable terminal described above includes:

a unit connected to the first local area network;

a unit for accepting the connection command to the second local area network from the user and connecting to the content relay device through the connection unit using the address of the content relay device stored in the address storage unit;

a unit for accepting the command from the user to display the remote content list and outputting a remote content list acquisition request to the content relay device;

a unit for receiving the remote content list data from the content relay device and storing it in the content information storage unit;

a unit for displaying a list of the content names contained in the remote content list data stored in the content information storage unit; and

a unit for accepting from the user the remote content reproduction command containing the designation of the remote content to be reproduced, and outputting to the reproduction unit the remote content reproduction request including the address of the content relay device stored in the address storage unit and the second location information of the remote content to be reproduced, stored in the content information storage unit.

Incidentally, the portable terminal, the content relay device or the remote content reproduction system described above can be implemented by hardware execution of the aforementioned process according to a program stored in, for example, a flexible disk, a CD-ROM, a magnetooptic disk, a semiconductor memory or the like computer-readable storage medium or storage device. Also, such a program may be distributed by a digital signal through a network. Incidentally, the data being processed is provisionally held in a storage device such as a computer memory.

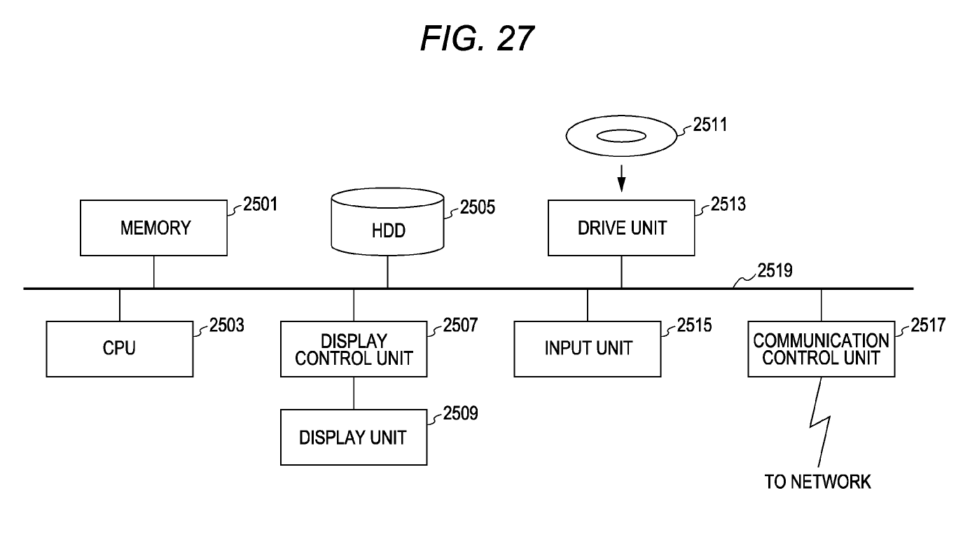

The control terminal 5 depicted in FIG. 1 is a computer system such as depicted in FIG. 27 and includes, interconnected by a bus 2519, a memory 2501 (storage device), a CPU 2503 (processing unit), a hard disk drive (HDD) 2505, a display control unit 2507 connected to a display device 2509, a drive unit 2513 for a removable disk 2511, an input unit 2515 and a communication control unit 2517 for connection to the network. The operating system (OS) and the application program for executing the process according to this embodiment are stored in the HDD 2505, and at the time of execution by the CPU 2503, read out to the memory 2501 from the HDD 2505. The CPU 2503 controls the display control unit 2507, the communication control unit 2517 and the drive unit 2513 to perform the required operation whenever necessary. The data being processed is stored in the memory 2501, and if required, stored in the HDD 2505. According to an embodiment, the application program to execute the process described above is stored in and distributed by the computer-readable removable disk 2511 and installed in the HDD 2505 from the drive unit 2513. The application program may alternatively be installed into the HDD 2505 through a network such as the internet and the communication control unit 2517. This computer system exhibits the aforementioned various functions by organic collaboration between the hardware such as the CPU 2503 and the memory 2501 on the one hand and the OS and the required application program on the other hand.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present inventions have been described in detail, it should be understood that the various changes, substitutions, and alterations could be made hereto without departing from the spirit and scope of the invention.

1. A portable terminal for instructing a reproduction unit capable of reproducing a content to reproduce the content, comprising:
a means for connecting to a first local area network connected with the reproduction unit;
a means for accepting a command from a user to connect to a second local area network and connecting to a second connection unit of the second local area network through a first connection unit of the first local area network using an address of the second connection unit stored in an address storage unit connected to an external network connected with the first connection unit to store the address of the second connection unit;
a means for accepting a command from the user to display a list of remote contents held by a predetermined device in the second local area network and outputting a remote content list acquisition request to the second connection unit;
a means for receiving, from the second connection unit, remote content list data including, for each remote content, location information containing a remote content identifier and a hash value indicating the completion of authentication and indicating the location of the remote content on the one hand and the name of the remote content on the other hand, and storing the remote content list data in a content information storage unit;
a means for displaying a list of the content names included in the remote content list data stored in the content information storage unit; and
a means for accepting, from the user, a reproduction command including the designation of the remote content to be reproduced and outputting, to the reproduction unit, a reproduction request containing the address of the second connection unit stored in the address storage unit and the location information of the remote content to be reproduced, stored in the content information storage unit.

2. A content relay device of a second local area network connected to a connection unit of a first local area network through an external network, comprising:
a content table holding, for each content held by each predetermined device in the second local area network, an identifier, a content name, an address of the predetermined device holding the content and first location information indicating the location of the content;
a means for receiving authentication information from a control terminal of the first local area network to execute an authentication process;
a means for calculating, if the authentication process succeeds, a hash value indicating the completion of authentication and storing a valid period of the hash value and the control terminal identifier in correspondence with each other in a terminal management table;
a location information generating means which, upon reception of a content list acquisition request from the control terminal, generates second location information including an identifier of each content stored in the content table and the hash value stored in the terminal management table and corresponding to the control terminal at the transmitting end of the content list acquisition request;
a means for generating content list data including, for each content, the second location information generated by the location information generating means and the content name stored in the content table, and transmitting the content list data to the control terminal of the transmitting end of the content list acquisition request received by the location information generating means;
a judgment means which upon reception of a reproduction request transmitted from the reproduction unit of the first local area network and including the second location information of the content to be reproduced, extracts the hash value from the second location information contained in the reproduction request and judges whether the reception of the reproduction request is stored in the terminal management table and the valid period corresponding to the hash value prevails or not;
a means which upon judgment that the reproduction request is received within the valid period, extracts the content identifier from the second location information contained in the reproduction request received by the judgment means, acquires the first location information and the address of the predetermined device corresponding to the extracted content identifier from the content table, and outputs the content data acquisition request including the acquired first location information to the acquired address of the predetermined device; and
a means which upon reception of the content data from the predetermined device having output the content data acquisition request, transmits the received content data to the reproduction unit at the transmitting end of the reproduction request received by the judgment means.

3. A remote content reproduction system comprising a content relay device of a second local area network, connected to a connection unit of a first local area network through an external network and a portable terminal connected to the first local area network to instruct a reproduction unit of the first local area network to reproduce a content,
wherein the content relay device includes:
a content table for storing an identifier and a content name of each remote content held by each predetermined device in the second local area network, an address of the predetermined device holding the remote content and first location information indicating the location of the remote content;
a means for executing an authentication process in accordance with a connection request from the portable terminal;
a means for calculating a hash value indicating the completion of authentication and storing the hash value in correspondence with a valid period of the hash value and the identifier of the portable terminal in a terminal management table in the case where the authentication process succeeds;
a location information generating means which upon reception of a remote content list acquisition request from the portable terminal, generates second location information including the identifier of each remote content stored in the content table and the hash value stored in the terminal management table and corresponding to the portable terminal at a transmitting end of the remote content list acquisition request;
a means for generating remote content list data containing, for each remote content, the second location information generated by the location information generating means and the content name stored in the content table, and transmitting the remote content list data to the portable terminal at the transmitting end of the remote content list acquisition request received by the location information generating means;
a judgment means which upon reception of the reproduction request from the reproduction unit including the second location information of the remote content to be reproduced, extracts the hash value from the second location information contained in the reproduction request and judges whether the reception of the reproduction request is stored in the terminal management table and the valid period corresponding to the hash value prevails;
a means which upon judgment that the reproduction request is received during the valid period, extracts the identifier of the remote content from the second location information included in the reproduction request received by the judgment means, acquires from the content table the first location information and the address of the predetermined device corresponding to the identifier of the remote content extracted, and outputs the remote content data acquisition request including the acquired first location information to the acquired address of the predetermined device; and
a means which upon reception of the remote content data from the predetermined device having output the remote content data acquisition request, transmits the received remote content data to the reproduction unit at the transmitting end of the reproduction request received by the judgment means, and
the portable terminal includes:
a means connected to the first local area network;
a means for accepting a connection command to the second local area network from the user and connecting to the content relay device through the connection unit using the address of the content relay device stored in the address storage unit;
a means for accepting a command from the user to display the remote content list and outputting the remote content list acquisition request to the content relay device;
a means for receiving the remote content list data from the content relay device and storing it in the content information storage unit;
a means for displaying a list of the content names contained in the remote content list data stored in the content information storage unit; and
a means for accepting from the user a remote content reproduction command containing the designation of the remote content to be reproduced, and outputting to the reproduction unit the remote content reproduction request including the address of the content relay device stored in the address storage unit and the second location information of the remote content to be reproduced, stored in the content information storage unit.
